(19) United States
(12) Patent Application Publication
(10) Pub. No.: US 2018/0252683 A1
(43) Pub. Date: Sep. 6, 2018

(54) CARBON DIOXIDE BASED CHROMATOGRAPHY SYSTEMS INCLUDING MULTIPLE PRESSURE CONTROL DEVICES

(71) Applicant: Waters Technologies Corporation, Milford, MA (US)

(72) Inventors: Michael O. Fogwill, South Grafton, MA (US); Joshua A. Shreve, Franklin, MA (US)

(21) Appl. No.: 15/909,258

(22) Filed: Mar. 1, 2018

Related U.S. Application Data
(60) Provisional application No. 62/466,526, filed on Mar. 3, 2017.

(51) Int. Cl. G01N 30/32; G01N 30/72

(52) U.S. Cl. CPC G01N 30/32; G01N 2030/326; G01N 30/724

(57) ABSTRACT

The present disclosure relates to methodologies, systems and devices for controlling pressure of a mobile phase in a CO₂-based chromatography system. A pump is used to pump a mobile phase containing CO₂ and is located upstream of a chromatography column. A primary pressure control element is located downstream of the chromatography column and controls the pressure of the mobile phase within the column. A secondary pressure control element is located downstream of the primary pressure control element and maintains the pressure of the mobile phase above a threshold value between an outlet of the primary pressure control element and the point of detection within a detector. The detector is located downstream of both the primary pressure control element and the secondary pressure control element.

### RELATED APPLICATIONS

This application claims the benefit of U.S. Provisional Patent Application 62/466,526 filed on Mar. 3, 2017 titled “CARBON DIOXIDE BASED CHROMATOGRAPHY SYSTEMS INCLUDING MULTIPLE PRESSURE CONTROL DEVICES,” the contents of which are incorporated herein by reference in its entirety.

### TECHNICAL FIELD

The present disclosure relates to techniques for controlling pressure in carbon dioxide-based chromatography systems. The present disclosure also relates to methodologies, systems and apparatus for controlling pressure downstream of a chromatography column.

### BACKGROUND OF THE TECHNOLOGY

Chromatography involves the flowing of a mobile phase over a stationary phase to effect the separation of analytes of interest. To speed-up and enhance the efficiency of the separation, pressurized mobile phases were introduced. Carbon dioxide based chromatographic systems use CO₂ as a component of the mobile phase, and the CO₂ based mobile phase is delivered from pumps and carried through the separation column as a pressurized liquid. In systems using CO₂ as a mobile phase component, one challenge is transferring the analyte and ensuring CO₂ and co-solvent miscibility downstream of the column. For example, even slight changes in temperature and/or pressure are known to create noticeable fluctuations in density. The changes in co-solvent and analyte solubility in the CO₂-based mobile phase become especially problematic do to the extreme changes in density experienced when interfacing the CO₂-based mobile phase to low pressure detection such as flame ionization detection or mass spectrometry.

### SUMMARY

Exemplary embodiments of the present technology are directed to systems for controlling pressure of a mobile phase. Further, the embodiments are related to methodologies, systems and apparatus that employ multiple pressure control elements to control pressure of a mobile phase. In particular, some embodiments are related to methodologies, systems and apparatus that are used in CO₂-based chromatography systems, i.e., a chromatography system in which the mobile phase includes CO₂. In general, some embodiments of the present technology provide increased stability and control over temperature and pressure levels in a CO₂-based chromatography system.

In one aspect, the present technology relates to a system of controlling pressure of a mobile phase. The system includes a pump for pumping a mobile phase including CO₂, the pump located upstream of a chromatography column. The system also includes a primary pressure control element located downstream of the column and disposed to control pressure of the mobile phase within the column. The system also includes a detector located downstream of the primary pressure control element. The system also includes a secondary pressure control element located downstream of the primary pressure control element. The secondary pressure control element is disposed to maintain a pressure of the mobile phase above a threshold value between an outlet of the primary pressure control element and the point of detection within the detector.

Embodiments of this aspect of the technology can include one or more of the following features. In some embodiments, the primary pressure control element is a back pressure regulator. In some embodiments, the secondary pressure control element maintains the pressure of the mobile phase between about 6.55 to 10.3 MPa (950 to 1500 psi). In some embodiments, an outlet of the secondary pressure control element is located within 5.0 cm from the point of detection within the detector. In some embodiments, the detector is a flame ionization detector and the point of detection is the flame. In other embodiments, the detector is a mass spectrometer and the point of detection is the electrospray ionization plume/spray. In still other embodiments, the detector can include an aerosol-based detector, such as an evaporative light scattering detector, condensation nucleation detector, or a charged aerosol detector. In some embodiments, the secondary pressure control element prevents phase separation between CO₂ and a liquid co-solvent while transporting the analyte from the primary pressure control element to the detector. In some embodiments, the secondary pressure control element is incorporated into a section of tubing disposed between the outlet of the primary pressure control element and the point of detection. In some embodiments, the secondary pressure control element has a diameter between 0.1 microns and 100 microns, and a length between 0.1 microns and 100 centimeters. In some embodiments, the secondary pressure control element is a restrictor, a back pressure regulator, or a variable restrictor. A fixed restrictor may be a linear, tapered, converging-diverging, integral, or fritted restrictor. A variable restrictor may be a thermally-modulated variable restrictor.

In another aspect, the present technology relates to a method of controlling pressure of a mobile phase in a CO₂-based chromatography system. The method includes controlling pressure of the mobile phase within a column of a CO₂-based chromatography system using a primary pressure control element located downstream of the column. The method also includes maintaining a pressure of the mobile phase above a threshold value between an outlet of the primary pressure control element and an inlet of a detector using a secondary pressure control element located downstream of the primary pressure control element.

Embodiments of this aspect of the technology can include one or more of the following features. In some embodiments, the primary pressure control element is a back pressure regulator. In some embodiments, the secondary pressure control element maintains the pressure of the analyte between about 6.55 to 10.3 MPa (950 to 1500 psi). In some embodiments, an outlet of the secondary pressure control element is located within 5.0 cm from the point of detection. In some embodiments, the detector is a flame ionization detector or a mass spectrometer. In some embodiments, the secondary pressure control element prevents phase separation between CO₂ and a liquid co-solvent while transporting the analyte from the primary pressure control element to the detector. In some embodiments, the secondary pressure control element is incorporated into a section of tubing disposed between the outlet of the primary pressure control element and the point of detection. In some embodiments, the secondary pressure control element has a diameter between 0.1 microns to 100 microns, and a length between 0.1 microns and 100 centimeters. In some embodiments, the secondary pressure control element is a restrictor.

In another aspect, the present technology relates to a device for managing pressure within a CO₂-based chromatography system. The device includes a pressure control element having a diameter between 0.1 microns and 100 microns, and a length between 0.1 microns and 100 centimeters. The first end of the pressure control element is disposed to receive a fluid from a back pressure regulator, and the second end of the pressure control element is disposed to transmit the fluid to a detector. The pressure control element is disposed to maintain a pressure of the fluid above a threshold value.

Embodiments of this aspect of the technology can include one or more of the following features. In some embodiments, the diameter of the pressure control element is greater at the first end than at the second end. In some embodiments, the second end of the pressure control element is located within 5.0 cm from the point of detection. In some embodiments, the pressure control element prevents phase separation between CO₂ and a liquid co-solvent while transporting the fluid from the back pressure regulator to the detector.

The above aspects of the technology provide one or more of the following advantages. Some embodiments of the technology allow for more efficient full-flow introduction of the mobile phase stream to a low-pressure detector when employing a back pressure regulator. The secondary pressure control device described herein helps ensure proper mobile phase density all the way into the detector. In some embodiments, the secondary pressure control device prevents or reduces phase separation and analyte precipitation. As a result, there is less down time due to the minimization of precipitation. In addition, as more sample is provided to the detector, increased detector response is possible. Further, the analyte is delivered to the detector in a fashion which promotes good peak shape and provides for good quantitation.

### BRIEF DESCRIPTION OF THE DRAWINGS

The foregoing and other features and advantages provided by the present disclosure will be more fully understood from the following description of exemplary embodiments when read together with the accompanying drawings presented below.

FIG. 1 is a block diagram illustrating an exemplary prior art full-flow CO₂-based chromatography system.

FIG. 2 is a block diagram illustrating an exemplary prior art split-flow CO₂-based chromatography system.

FIG. 3 is a block diagram illustrating an exemplary CO₂-based chromatography system including a secondary pressure control device, according to an embodiment of the present disclosure.

FIG. 4 is a chromatogram of a separation of caffeine and sulfadimethoxine with no secondary pressure control device.

FIG. 5 is a chromatogram of the separation performed in FIG. 4 with the addition of a secondary pressure control device between the primary pressure control device and the detector, according to an embodiment of the present disclosure.

FIG. 6 is a chromatogram comparing the UPC²-MS response to caffeine of a full-flow interface and a split-flow interface, according to an embodiment of the present disclosure.

FIG. 7 is a chromatogram comparing caffeine peak profiles between an interface containing a single pressure controlling element and an interface containing two pressure controlling elements, according to an embodiment of the present disclosure.

FIG. 8 is a cross sectional view of an exemplary pressure control element disposed within a MS probe assembly, according to embodiments of the present disclosure.

FIG. 9 is a flow chart of an exemplary method for maintaining pressure in a CO₂-based chromatography system, according to an embodiment of the present disclosure.

### DETAILED DESCRIPTION OF THE TECHNOLOGY

Provided herein are methodologies, systems, and apparatus for controlling pressure of a mobile phase in a CO₂-based chromatography system utilizing multiple pressure control devices. Interfacing analytical-scale CO₂-based chromatography systems to low pressure detection (e.g., flame ionization detection or mass spectrometry) poses a unique challenge due to the intricacies of managing analyte and co-solvent solubility in carbon dioxide as the mobile phase transitions from a pressurized state to a gas or ambient pressure state. Mobile phase decompression often results in analyte precipitation, or analyte loss, which prevents accurate and repeatable detection. Also, when operating with a liquid co-solvent, the depressurized carbon dioxide no longer has the ability to dissolve the modifier. Therefore, after depressurizing, the mobile phase stream consists of pockets of gaseous CO₂ pushing pockets of liquid modifier. This heterogeneous flow results in very inconsistent electrospray ionization (ESI) mass spectrometry (MS) spray and therefore inconsistent peak profile.

In one embodiment, employing an additional pressure regulation device or pressure control element in a CO₂-based chromatography system allows for efficient full-flow introduction of the mobile phase stream to a low-pressure detector when employing a conventional back pressure regulator. The secondary pressure control device ensures mobile phase density all the way into the detector, thereby preventing phase separation and analyte precipitation, which may occur without a secondary pressure control device.

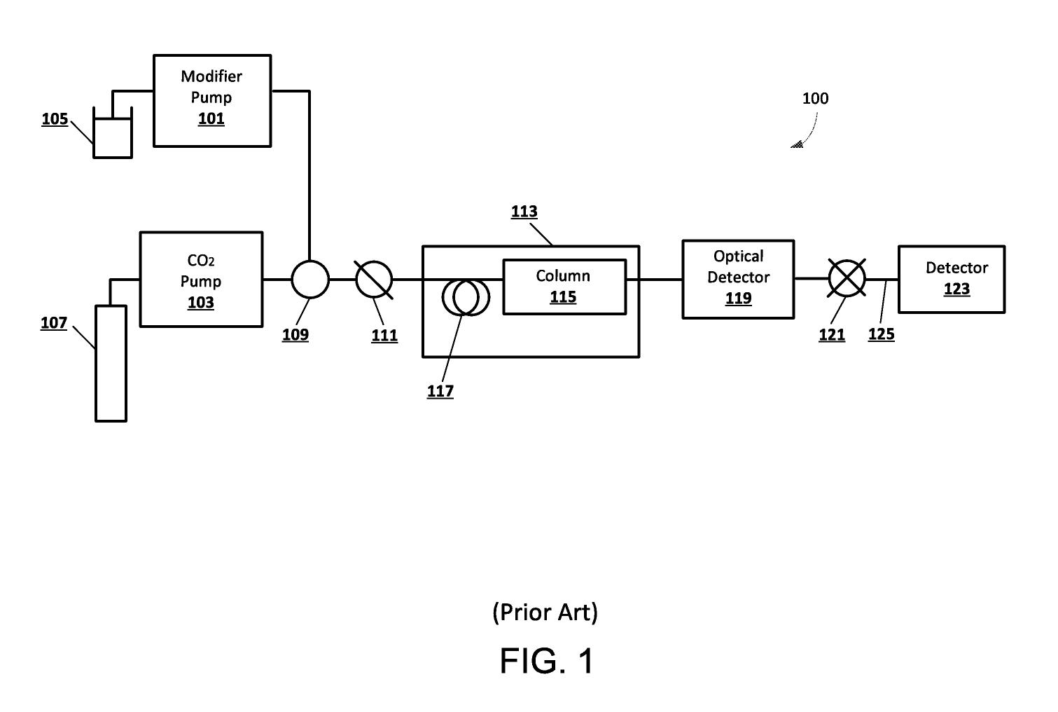

FIG. 1 is a block diagram illustrating an exemplary prior art full-flow CO₂-based chromatography system. In this particular example, a modifier pump 101 is used to pump a liquid modifier from a solvent reservoir 105 to a chromatography column 115 through a mixer 109 and injector 111. In parallel to the modifier pump 101, a CO₂ pump 103 is used to pump CO₂ from a CO₂ container 107 to the chromatography column 115 through the mixer 109 and injector 111. In this technological field, CO₂ pumps are pumps that are able to adequately pump CO₂ and often require cooling to maintain the CO₂ in a liquid-like state. In this example, the column 115 is located within a column oven 113, which includes preheating elements 117. An optional optical detector 119 may be located at the output of the chromatography column 115. A back pressure regulator (BPR) 121 is located downstream of the column 115 and upstream of a detector 123. The BPR 121 can be used to control pressure within the column 115. However, because the BPR 121 is of considerable size, it is generally placed at an appreciable distance from the detector 123. Therefore, a length of transfer tubing 125 is used between an outlet of the BPR 121 and the detector 123. Transporting analyte and assuring CO₂ and co-solvent miscibility through this length of tubing can be challenging. In some embodiments, a post-column addition pump or makeup fluid pump is used to aid in transporting analytes through the post-BPR tubing. The addition of liquid helps transport the analyte to detection, especially when operating with low percentages of co-solvent.

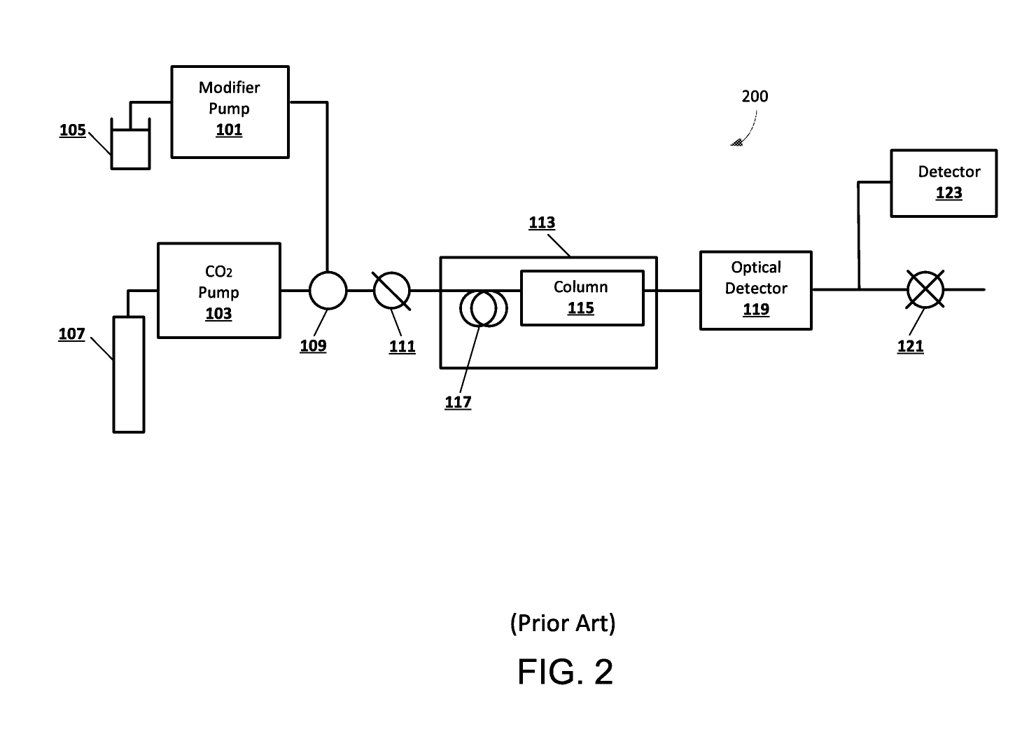

FIG. 2 is a block diagram illustrating an exemplary split-flow CO₂-based chromatography system. In this particular example, a modifier pump 101 is used to pump a liquid modifier from a solvent reservoir 105 to a chromatography column 115 through a mixer 109 and injector 111. In parallel to the modifier pump 101, a CO₂ pump 103 is used to pump CO₂ from a CO₂ container 107 to the chromatography column 115 through the mixer 109 and injector 111. In this example, the column 115 is located within a column oven 113, which includes preheating elements 117. An optional optical detector 119 may be located at the output of the chromatography column 115. The split-flow system differs from the system described in reference to FIG. 1 in that the detector 123 is split from the output of the detector 119 upstream of the BPR 121. In this embodiment, with proper restrictor design, the mobile phase retains appreciable solvating power until the analyte is within the detector 123. Only once the analyte is within the detector 123 is the mobile phase allowed to decompress. In this way, the split-flow interface helps address the challenges encountered when interfacing a system with a BPR 121 to a low-pressure detector 123. However, due to the use of a fixed restrictor, any change to the system pressure or mobile phase viscosity can result in a change in the split ratio and therefore interfere with quantitation. Also, since only a portion of the analyte is introduced to the detector 123, sensitivity is proportionally lower when employing a split-flow interface to detection.

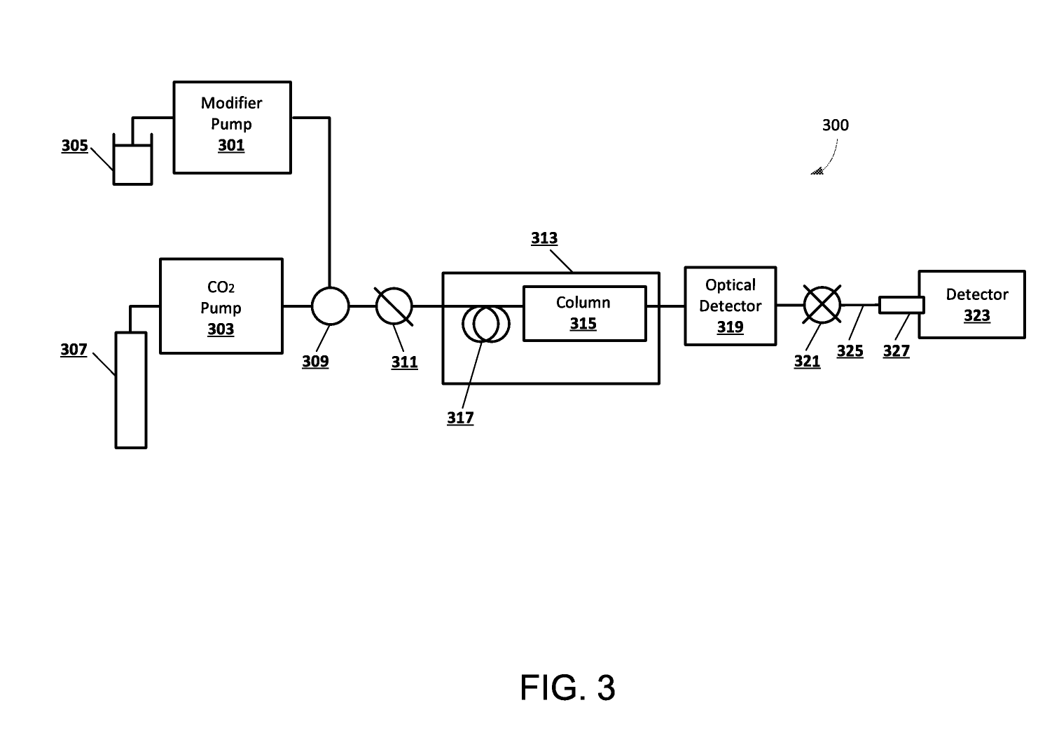

FIG. 3 is a block diagram illustrating an exemplary CO₂-based chromatography system including a secondary pressure control device, according to embodiments of the present disclosure. In this particular example, a modifier pump 301 is used to pump a liquid modifier from a solvent reservoir 305 to a chromatography column 315 through a mixer 309 and injector 311. In parallel to the modifier pump 301, a CO₂ pump 303 is used to pump CO₂ from a CO₂ container 307 to the chromatography column 315 through the mixer 309 and injector 311. In this example, the column 315 is located within a column oven 313. The column oven 313 includes preheating elements 317 used for heating and controlling the temperature of the mobile phase entering the column 315. An optional optical detector 319 may be located at the output of the chromatography column 315. A primary pressure control element 321 is located downstream of the column 315 and upstream of a detector 323. In some examples, the detector 323 can be a flame ionization detector or a mass spectrometer. In other non-limiting examples, the detector can include an aerosol-based detector such as an evaporative light scattering detector, a condensation nucleation detector, or a charged aerosol detector. In this embodiment, the primary pressure control element 321 is a BPR. The BPR 321 can be used to control pressure of the mobile phase within the column 315. However, because the BPR 321 is of considerable size, it is generally placed at an appreciable distance from the detector 323. Therefore, a length of transfer tubing 325 is used between an outlet of the BPR 321 and the detector 323.

The system also includes a secondary pressure control device 327 downstream of the primary pressure control device, or BPR 321. In some embodiments, the secondary pressure control device 327 is located as close as possible to the point of decompression inside the detector 323. In one embodiment, the outlet of the secondary pressure control element 327 can be located within 5.0 cm from the point of detection within the detector 323. In another embodiment, the secondary pressure control element 327 is incorporated into the section of tubing 325 disposed between the outlet of the primary pressure control element 321 and the point of detection within the detector 323. The secondary pressure control element 327 can be, for example, a restrictor, a back pressure regulator, or a variable restrictor. This particular example shows a secondary pressure control device 327 incorporated into a full-flow CO₂-based chromatography system. The addition of a secondary pressure control device 327 maintains the CO₂/co-solvent miscibility and improves analyte transport from the BPR 321 to the detector 323. The secondary pressure control device 327 addresses the limitations encountered with interfacing CO₂-based chromatography to detection and helps prevent phase separation while transporting the analyte from the primary pressure control device or BPR 321 to the detector 323.

In one exemplary embodiment, the secondary pressure control device 327 maintains the pressure of the mobile phase above a threshold value between the outlet of the primary pressure control device 321 to the point of detection within the detector 323. In some embodiments, the secondary pressure control element maintains the pressure of the mobile phase between about 6.55 to 10.3 MPa (950 to 1,500 psi). The secondary pressure control device can include, for example, a BPR, a fixed restrictor, or a variable restrictor such as a thermally modulated variable restrictor. In some embodiments, the secondary pressure control element 327 prevents phase separation between CO₂ and a liquid co-solvent while transporting the analyte from the primary pressure control element 321 to the detector 323. In some embodiments, the secondary pressure control element has a diameter between 0.1 microns and 100 microns, and a length between 0.1 microns and 100 centimeters.

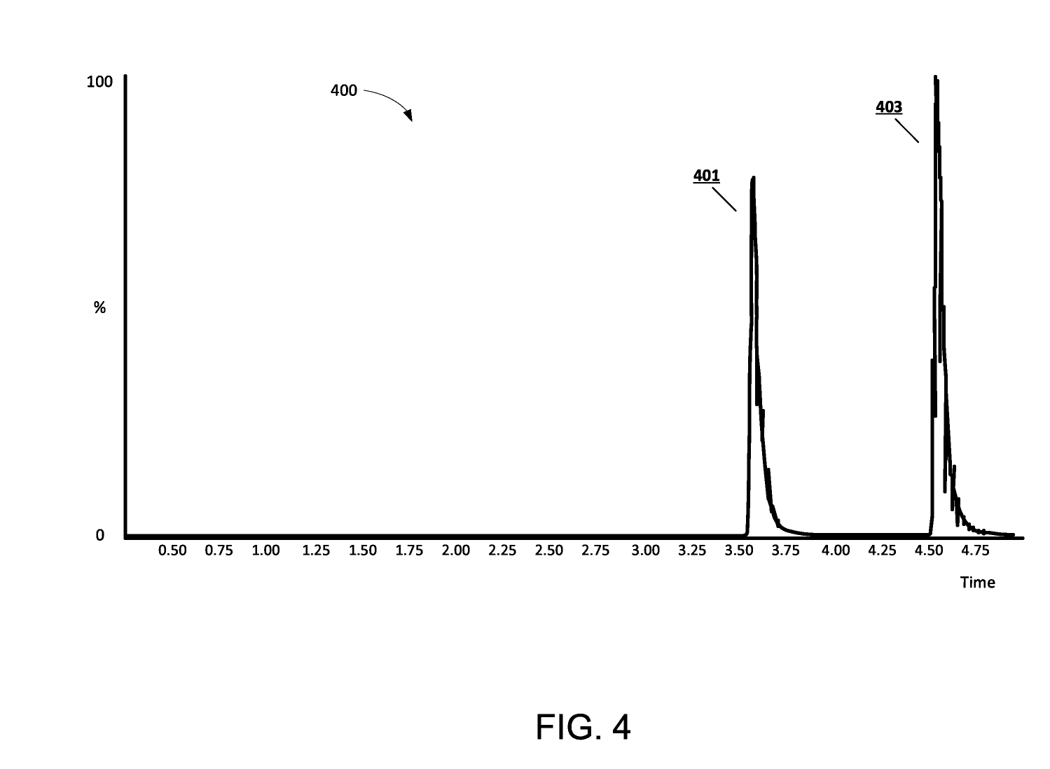

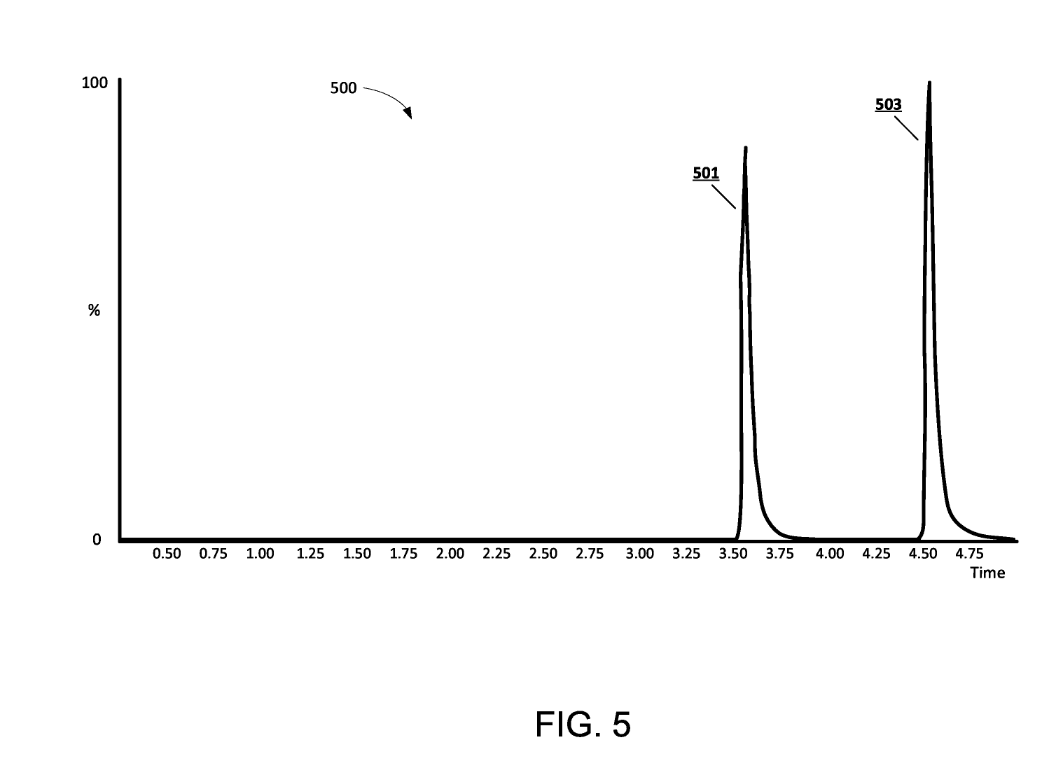

FIG. 4 is a chromatogram 400 of a separation of caffeine 401 and sulfadimethoxine 403 with no secondary pressure control device. Note the discontinuous peak profile. In the example shown in FIG. 4, a separation of caffeine 401 and sulfadimethoxine 403 was performed without the secondary pressure control device. This discontinuous peak shapes 401 and 403 are indicative of CO₂/co-solvent phase separation. The addition of a secondary pressure control device, as shown in FIG. 5, can provide improved miscibility between CO₂ and the co-solvent between the primary pressure control device, or BPR, and the detector.

FIG. 5 is a chromatogram 500 of the same separation performed in FIG. 4, with the addition of a secondary pressure control device between the primary pressure control device and the detector, according to embodiments of the present disclosure. In this example embodiment, a separation of caffeine 501 and sulfadimethoxine 503 was performed with the secondary pressure control device located between the primary pressure control device and the detector. As discussed above, the secondary pressure control device can be located at or near the end of a transfer line between the primary pressure control device and the detector. Note the smooth peak profiles 501 and 505, as compared to the peaks in FIG. 4. The smoother peak profiles are indicative of improved analyte transport.

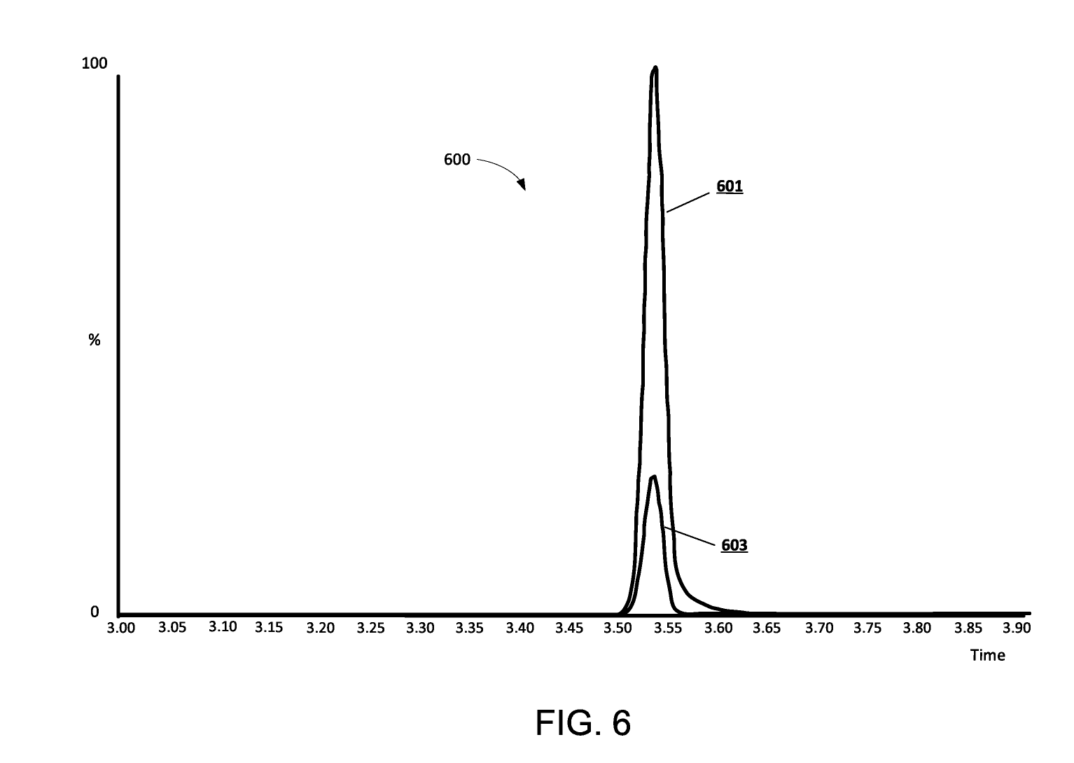

FIG. 6 is a chromatogram 600 comparing the UPC²-MS response of a full-flow interface and a split-flow interface, according to embodiments of the present disclosure. In this particular example, the chromatogram 600 shows a comparison of the UPC²-MS response of caffeine in a full-flow interface 601 and a split-flow interface 603. As discussed above, in a split-flow interface only a portion of the analyte is directed to the detector, and therefore peak 603 is lower than peak 601. Accordingly, in a full-flow interface 601 sensitivity is higher because all of the analyte is directed to the detector.

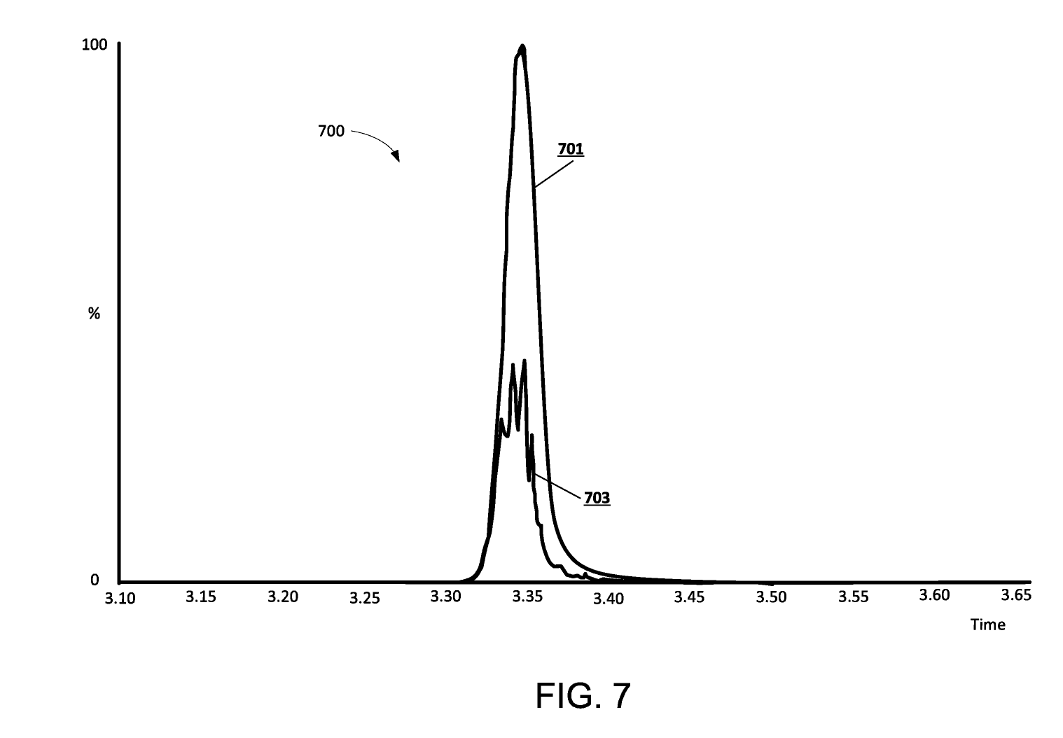

FIG. 7 is a chromatogram 700 comparing peak profiles between an interface containing a single pressure controlling element and an interface containing two pressure controlling elements, according to embodiments of the present disclosure. In this particular example, graph 700 shows the comparative caffeine peak profiles between a UPC²-MS interface containing a single pressure controlling element 703 and an interface containing two pressure controlling elements 701. The spiked peak profile and poor response in 703 is indicative of poor post-BPR transport. However, 701 shows how transport is improved by implementing a second pressure-controlling element.

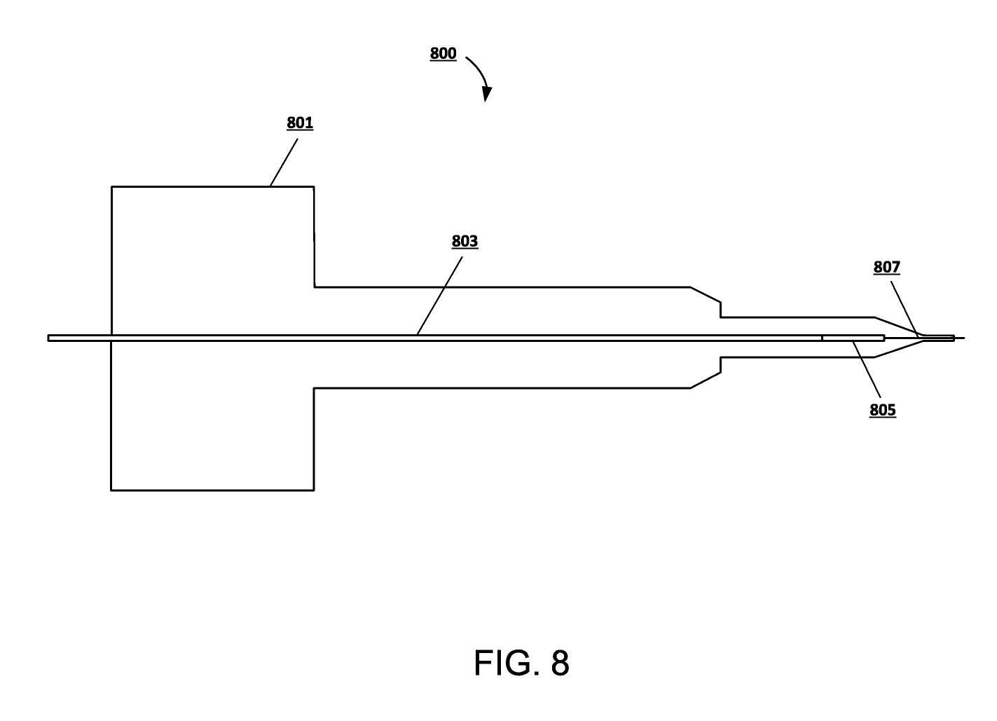

FIG. 8 is a cross sectional view of an exemplary pressure control element 805 disposed within a MS probe assembly 800, according to embodiments of the present disclosure. In this particular embodiment, the MS probe assembly 800 includes a MS probe 801, a mobile phase transfer line 803, a pressure control element 805, and an ESI emitter 807. As discussed above, the pressure control element 805 can be located downstream of the primary pressure control element, such as a back pressure regulator (not shown), and can be configured to maintain a pressure of the mobile phase above a threshold value between the outlet of the back pressure regulator and the point of detection within the detector. In exemplary embodiments, the pressure control element 805 can have a diameter between about 0.1 microns to about 100.0 microns, and can have a length between about 0.1 microns to about 100.0 centimeters. In some embodiments, the diameter of the pressure control element 805 is greater at the first upstream end than at the second downstream end. If the internal diameter of the pressure control element 805 is too large, or does not provide enough restriction, the device may not provide adequate back-pressure to ensure mobile phase/co-solvent miscibility. The pressure control element 805 can receive a fluid from the back pressure regulator at a first end, and can transmit the fluid to a detector at a second end. The second end of the pressure control element 805 can be located within about 5.0 centimeters from an point of detection, in some embodiments, and can minimize the post-decompression system volume. The pressure control element 805 can prevent phase separation between CO₂ and a liquid co-solvent while transporting the fluid from the back pressure regulator to the detector.

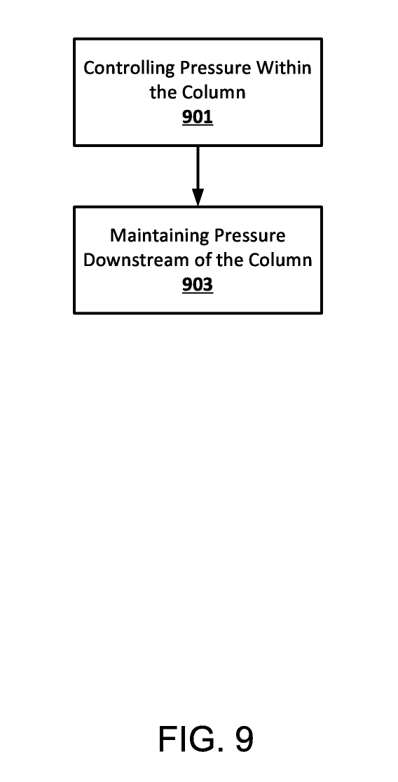

FIG. 9 is a flow chart 900 of an exemplary method for maintaining pressure in a CO₂-based chromatography system, according to an embodiment of the present disclosure. In step 901, the pressure within a CO₂-based chromatography column is controlled using a primary pressure control element located downstream of the column. In some embodiments, the primary pressure control element is a back pressure regulator.

In step 903, the pressure downstream of the column maintained above a threshold value using a secondary pressure control element. The secondary pressure control element is located downstream of the primary pressure control element, and is configured to maintain the pressure of the mobile phase above a threshold value between an outlet of the primary pressure control element and an inlet of a detector. In some embodiments, the secondary pressure control element maintains the pressure of the mobile phase between about 6.55 to 10.3 MPa (or between about 950 to about 1500 psi). The outlet of the secondary pressure control element can be located within about 5.0 cm from the point of detection within the detector. The detector can be a flame ionization detector or a mass spectrometer. In other non-limiting examples, the detector can include an aerosol-based detector such as an evaporative light scattering detector, a condensation nucleation detector, or a charged aerosol detector. In some embodiments, the secondary pressure control element prevents phase separation between CO₂ and a liquid co-solvent while transporting an analyte from the primary pressure control element to the detector. The secondary pressure control element can be incorporated into a section of tubing between the outlet of the primary pressure control element and the point of detection within the detector. In some embodiments, the secondary pressure control element is a restrictor and can have a diameter between 0.1 microns to 100 microns, and a length between 0.1 microns and 100 centimeters.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

In alternative embodiments, the techniques described above with respect to pressure control elements used in CO₂-based chromatography systems may be applicable to pressure control elements used in other types of chromatography systems that include mobile phases that vary greatly in density with minor changes in temperature. For example, a mobile phase including methanol at extremely high pressures may in some instances benefit from added temperature control. In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a plurality of system elements, device components or method steps, those elements, components or steps may be replaced with a single element, component or step. Likewise, a single element, component or step may be replaced with a plurality of elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the invention. Further still, other aspects, functions and advantages are also within the scope of the invention.

What is claimed is:

1. A system of controlling pressure of a mobile phase, the system comprising:
a pump for pumping a mobile phase including CO₂, the pump located upstream of a chromatography column;
a primary pressure control element located downstream of the column and disposed to control pressure of the mobile phase within the column;
a detector located downstream of the primary pressure control element; and
a secondary pressure control element located downstream of the primary pressure control element and disposed to maintain a pressure of the mobile phase above a threshold value between an outlet of the primary pressure control element and the point of detection within the detector.

2. The system of claim 1, wherein the primary pressure control element is an active back pressure regulator.

3. The system of claim 1, wherein the secondary pressure control element maintains the pressure of the analyte between about 6.55 to 10.3 MPa (950 to 1500 psi).

4. The system of claim 1, wherein an outlet of the secondary pressure control element is located within 5.0 cm from the point of detection.

5. The system of claim 1, wherein the detector is a flame ionization detector, a mass spectrometer, or an aerosol-based detector.

6. The system of claim 1, wherein the secondary pressure control element prevents phase separation between CO₂ and a liquid co-solvent while transporting the analyte from the primary pressure control element to the detector.

7. The system of claim 1, wherein the secondary pressure control element is incorporated into a section of tubing disposed between the outlet of the primary pressure control element and the point of detection within the detector.

8. The system of claim 7, wherein the secondary pressure control element has a diameter between 0.1 microns and 100 microns, and a length between 0.1 microns and 100 centimeters.

9. The system of claim 1, wherein the secondary pressure control element is a restrictor, a back pressure regulator, or a variable restrictor.

10. A method of controlling pressure of a mobile phase in a CO₂-based chromatography system, the method comprising:
controlling pressure of the mobile phase within a column of a CO₂-based chromatography system using a primary pressure control element located downstream of the column; and
maintaining a pressure of the mobile phase above a threshold value between an outlet of the primary pressure control element and the point of detection within a detector using a secondary pressure control element located downstream of the primary pressure control element.

11. The method of claim 10, wherein the primary pressure control element is a back pressure regulator.

12. The method of claim 10, wherein the secondary pressure control element maintains the pressure of the analyte between about 6.55 to 10.3 MPa (950 to 1500 psi).

13. The method of claim 10, wherein an outlet of the secondary pressure control element is located within 5.0 cm from the point of detection.

14. The method of claim 10, wherein the secondary pressure control element prevents phase separation between CO₂ and a liquid co-solvent while transporting the analyte from the primary pressure control element to the detector.

15. The method of claim 10, wherein the secondary pressure control element is incorporated into a section of tubing disposed between the outlet of the primary pressure control element and the point of detection within the detector.

16. The method of claim 15, wherein the secondary pressure control element has a diameter between 0.1 microns to 100 microns, and a length between 0.1 microns and 100 centimeters.

17. The method of claim 10, wherein the secondary pressure control element is a BPR, restrictor, or variable restrictor.

18. A device for managing pressure within a CO₂-based chromatography system, the device comprising:
a pressure control element having a diameter between 0.1 microns and 100 microns, and a length between 0.1 microns and 100 centimeters;
a first end of the pressure control element disposed to receive a fluid from a back pressure regulator; and
a second end of the pressure control element disposed to transmit the fluid to a detector;
wherein the pressure control element is disposed to maintain a pressure of the fluid above a threshold value.

19. The device of claim 18, wherein the diameter of the pressure control element is greater at the first end than at the second end.

20. The device of claim 18, wherein the pressure control element prevents phase separation between CO₂ and a liquid co-solvent while transporting the fluid from the back pressure regulator to the detector.
